(19) United States
(12) Patent Application Publication
(10) Pub. No.: US 2026/0272208 A1
(43) Pub. Date: Sep. 17, 2026

(54) Top-mounted ultrasonic extraction device

(71) Applicant: Qiuyu RUAN, Chongqing (CN)

(72) Inventor: Qiuyu RUAN, Chongqing (CN)

(21) Appl. No.: 19/090,344

(22) Filed: Mar. 25, 2025

(30) Foreign Application Priority Data
Mar. 11, 2025 (CN) 202520421155.6

(51) Int. Cl. A47J 31/20; A47J 31/44; A47J 43/046; B01D 11/02

(52) U.S. Cl. CPC A47J 31/20; A47J 31/4407; A47J 43/046; B01D 11/0265

(57) ABSTRACT

Disclosed is a top-mounted ultrasonic extraction device, including: a kettle body, where a kettle lid is detachably arranged on a top of the kettle body, a first installation chamber is arranged inside the kettle lid, an ultrasonic assembly is fixedly installed inside the first installation chamber, an extraction chamber and a second installation chamber are sequentially vertically arranged inside the kettle body, the second installation chamber is arranged in a sealed manner, a stirrer is arranged inside the second installation chamber, the ultrasonic assembly is connected to a kinetic energy transfer component, and the kinetic energy transfer component extends into the extraction chamber. The ultrasonic assembly generates vibrations at a frequency of 20-50 kHz, and the vibrations are transmitted to the extraction chamber. A cavitation effect of ultrasonic waves ensures thorough dissolution of water-soluble substances, flavor concentration, more full aroma release, and reduction of bitterness.

### RELATED APPLICATIONS

The present patent document claims the benefit of priority to Patent Application No. 202520421155.6, filed Mar. 11, 2025, and entitled “top-mounted ultrasonic extraction device,” the entire contents of each of which are incorporated herein by reference.

### BACKGROUND

### 1. Technical Field

The present disclosure relates to the technical field of coffee extraction, and in particular to a top-mounted ultrasonic extraction device.

### 2. Background Information

A coffee solution can be obtained after extracting coffee powder, and then after further processing, finished coffee powder is extracted from the coffee solution. Generally, coffee extraction is achieved by means of high-temperature heating, resulting in that an extracted coffee solution has flavor defects such as off-flavor, tart flavor, astringency, strong bitterness and the like, and the coffee is hardly high-quality.

Cold brew coffee extraction is an extraction method used to preserve original aroma of coffee by soaking coffee powder in cold water to extract water-soluble components in the coffee powder. To accelerate the extraction, a stirring device is usually arranged in an extraction cylinder where the coffee powder is soaked, and the stirring device agitates to speed up dissolution of the water-soluble components from the coffee powder in cold water. However, the prior art has the following defects: the coffee powder obtained by stirring has low solubility, resulting in poor flavor.

Therefore, it is urgent to design a top-mounted ultrasonic extraction device to overcome the above one or more defects in the prior art, which improves a low-temperature extraction rate while ensuring flavor quality.

### BRIEF SUMMARY

The technical solution adopted by the present disclosure to solve the above technical problems is as follows: a top-mounted ultrasonic extraction device, including: a kettle body, where a kettle lid is detachably arranged on a top of the kettle body, a first installation chamber is arranged inside the kettle lid, an ultrasonic assembly is fixedly installed inside the first installation chamber, an extraction chamber and a second installation chamber are sequentially vertically arranged inside the kettle body, the second installation chamber is arranged in a sealed manner, a stirrer is arranged inside the second installation chamber, the ultrasonic assembly is connected to a kinetic energy transfer component, and the kinetic energy transfer component extends into the extraction chamber; and the ultrasonic assembly generates vibrations at a frequency of 20-50 kHz, and the vibrations are transmitted to the extraction chamber through the kinetic energy transfer component.

In a preferred example, the ultrasonic assembly includes: a housing, where a circuit board is arranged at a bottom of the housing, an ultrasonic generator is arranged in a middle of the circuit board, a plurality of support rods are arranged around a circumferential side of the circuit board, one end of each of the support rods, away from the circuit board, is connected to a vibration plate, the ultrasonic generator is further connected to the vibration plate, and the kinetic energy transfer component is connected to the vibration plate.

In a preferred example, a bottom of the circuit board is spaced apart from the bottom of the housing through the support columns.

In a preferred example, the kettle body is made of stainless steel, silicone, or glass.

In a preferred example, the stirrer includes: a control board, a motor, and a stirring paddle; the control board and the motor are located inside the second installation chamber, and the stirring paddle is located outside the second installation chamber and is connected to an output end of the motor.

In a preferred example, power of the ultrasonic assembly is 50-200 W.

The present disclosure has the following beneficial effects: the cavitation effect of ultrasonic waves significantly shortens extraction time, enhances the extraction effect, accelerates the dissolution of water-soluble substances, and ensures thorough dissolution of water-soluble substances, flavor concentration, more full aroma release, and reduction of bitterness; and low-temperature stirring enables to reduce the loss of volatile aromas in coffee and enhance the taste smoothness, which is suitable for a wide range of applications, and facilitates mass production.

### BRIEF DESCRIPTION OF THE DRAWINGS

FIG. 1 is a structural schematic diagram of the present disclosure.

FIG. 2 is an exploded view of the present disclosure.

FIG. 3 is a sectional view of the present disclosure.

### REFERENCE NUMERALS IN THE FIGURES

10—kettle body; 11—kettle lid; 12—stirrer; 121—control board; 122—motor; 123—stirring paddle; 13—extraction chamber; 14—first installation chamber; 15—ultrasonic assembly; 151—housing; 152—circuit board; 153—ultrasonic generator; 154—support rod; 155—vibration plate; 156—support column; 157—kinetic energy transfer component; and 16—second installation chamber.

### DETAILED DESCRIPTION OF THE DRAWINGS AND THE PRESENTLY PREFERRED EMBODIMENTS

In order to enable the objectives, features, and advantages mentioned above of the present disclosure to be more apparent and easily understood, specific implementations of the present disclosure will be described in detail below with reference to the drawings. Numerous specific details are set forth in the following description to facilitate a thorough understanding of the present disclosure. However, the present disclosure can be implemented in many other ways than those described herein, and those skilled in the art may make similar modifications without departing from the spirit of the present disclosure, and therefore the present disclosure is not to be limited by the specific embodiments disclosed below.

In the description of the examples of the present disclosure, it should be noted that, unless otherwise explicitly specified and defined, the terms “connection” and “mounting” should be understood in a broad sense. For example, “connection” may be a detachable connection, a non-detachable connection; and may be a direct connection, or an indirect connection via an intermediate medium. Further, “communication” may be a direct communication or an indirect communication via an intermediate medium. The term “fixed” refers to an interconnection where the relative positional relationship remains unchanged after the connection. The orientation terms mentioned in the present disclosure, such as “inside”, “outside”, “top”, “bottom” and the like, only indicate the directions in the accompanying drawings. Therefore, the orientation terms are used to better illustrate and understand the embodiments of the present disclosure, and are not intended to indicate or imply that the referenced device or element must have a particular orientation and be constructed and operative in a particular orientation, and thus may not be construed as a limitation on the embodiments of the present disclosure.

In the embodiments of the present disclosure, the terms “first” and “second” are only used for descriptive purposes, and should not be construed as indicating or implying relative importance or implicitly indicating the number of technical features indicated. Thus, a feature defined with “first” and “second” may explicitly or implicitly include one or more of the features.

In the embodiments of the present disclosure, the term “and/or”, which is merely an association relation describing an associated object, means that there may be three relations, for example, A and/or B may represent three situations: A exists alone, A and B exist at the same time, and B exists alone. In addition, the character “/” in the description generally indicates that successive association objects are in an “or” relation.

In the present specification, the description of reference terms such as “one embodiment” and “some embodiments” means that specific features, structures or characteristics described in combination with this embodiment are included in one or more embodiments of the present disclosure. Therefore, the statements appearing in different parts of the present specification, such as “in one embodiment”, “in some embodiments”, “in other embodiments”, “in some other embodiments” and the like, do not necessarily refer to the same embodiment, but mean “one or more, but not all embodiments”, unless otherwise specifically emphasized in any other way. The terms “including”, “containing”, “having” and any variations thereof mean “including but not limited to”, unless otherwise specifically emphasized in any other way. Therefore, the present disclosure is not to be limited by the specific embodiments disclosed below.

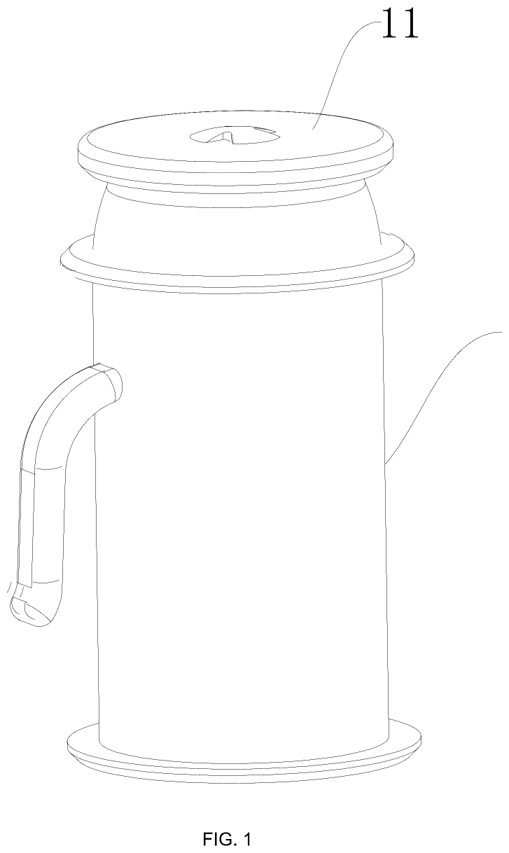

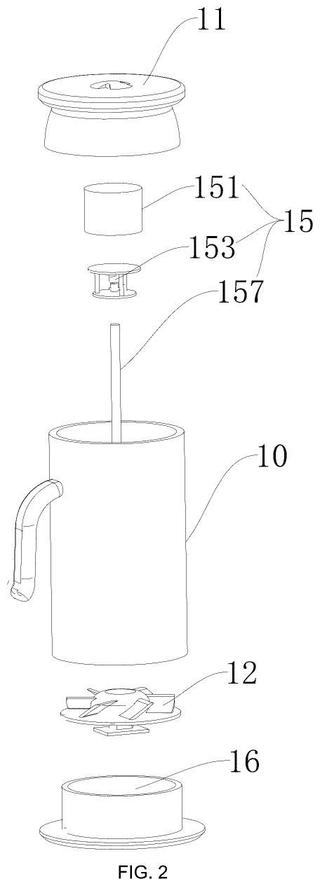

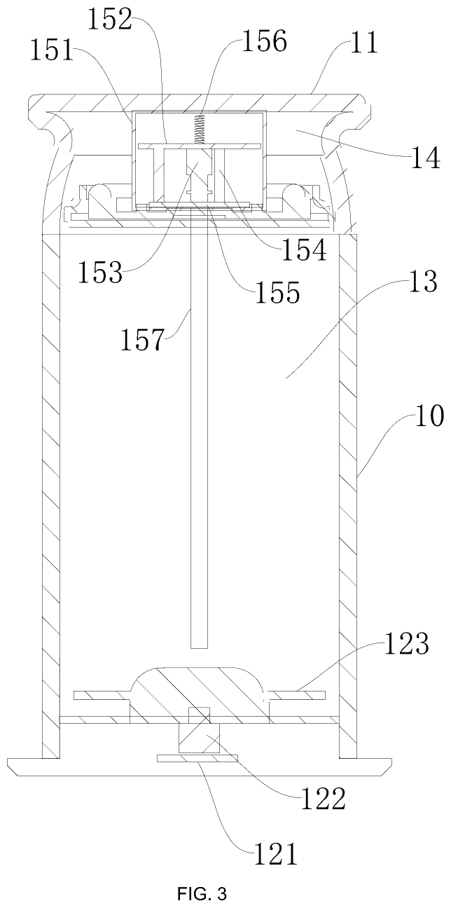

As illustrated in FIGS. 1-3, a top-mounted ultrasonic extraction device is provided by the present disclosure, including: a kettle body 10, where a kettle lid 11 is detachably arranged on a top of the kettle body 10, a first installation chamber 14 is arranged inside the kettle lid 11, an ultrasonic assembly 15 is fixedly installed inside the first installation chamber 14, an extraction chamber 13 and a second installation chamber 16 are sequentially vertically arranged inside the kettle body 10, the second installation chamber 16 is arranged in a sealed manner, a stirrer 12 is arranged inside the second installation chamber 16, the ultrasonic assembly 15 is connected to a kinetic energy transfer component 157, and the kinetic energy transfer component 157 extends into the extraction chamber 13; and the ultrasonic assembly 15 generates vibrations at a frequency of 20-50 kHz, and the vibrations are transmitted to the extraction chamber 13 through the kinetic energy transfer component 157; and

specifically, the kettle lid 11 and the kettle body 10 are detachably connected in a spiral manner, which ensures both connection tightness and sealing effect; the kettle body 10 is vertically divided into the extraction chamber 13 and the second installation chamber 16, the extraction chamber 13 is configured to place liquid to be extracted, the second installation chamber 16 is arranged in a sealed manner, the stirrer 12 is arranged inside the second installation chamber 16, a working end of the stirrer 12 is located inside the extraction chamber 13, the installation chamber 14 is arranged inside the kettle lid 11, and the ultrasonic assembly 15 is arranged inside the first installation chamber 14; the ultrasonic assembly 15 is connected to the kinetic energy transfer component 157, and the kinetic energy transfer component 157 extends into the extraction chamber 13; the ultrasonic assembly 15 is capable of generating vibrations at a frequency of 20-50 kHz, and the vibrations are transmitted to the extraction chamber 13 through the kinetic energy transfer component 157 to cause high-frequency vibrations of liquid in the extraction chamber 13, ultrasonic extraction enables to generate tiny bubbles in the liquid, and these bubbles release shockwaves when bursting, which will crush cell walls of coffee powder, and accelerate dissolution of soluble substances such as sugar, lipid and aromatic molecules; due to the high-frequency vibrations during the ultrasonic extraction, extraction efficiency can be enhanced by 30%-50%, and extraction time can be reduced by 5-10 min, which is much shorter than traditional extraction time; moreover, the high-frequency vibrations from ultrasonic waves ensure more thorough dissolution of coffee powder, flavor concentration, more full aroma release, shortened extraction, effective reduction of bitterness, and preservation of nutritional components; and to prevent loss of flavor substances, in the present disclosure, ultrasonic operation time is set to 5 min, the stirrer 12 is arranged in the kettle lid 11, and when the ultrasonic operation stops, the stirrer 12 at a bottom of the kettle body 10 can be used to achieve low-speed stirring, so as to prevent the loss of flavor substances and ensure fusion of the flavor substances.

It should be noted that an operating temperature in the extraction chamber 13 must be controlled at 0-40° C. to minimize the loss of volatile substances in coffee, reduce excessive release of tannic acid and caffeine, and enhance taste smoothness. Compared to traditional hot water extraction, the present disclosure retains more floral/fruity aromas, acidity levels and delicate flavors, and at the ultrasonic frequency of 20-50 kHz, a cavitation effect enables to disrupt an emulsification structure of coffee and reduce emulsification phenomena.

Further, in this example, the ultrasonic assembly 15 includes: a housing 151, where a circuit board 152 is arranged at a bottom of the housing 151, an ultrasonic generator 153 is arranged in a middle of the circuit board 152, a plurality of support rods 154 are arranged around a circumferential side of the circuit board 152, one end of each of the support rods 154, away from the circuit board 152, is connected to a vibration plate 155, the ultrasonic generator 153 is further connected to the vibration plate 155, and the kinetic energy transfer component 157 is connected to the vibration plate 155; and

specifically, the housing 151 is provided with an opening on a top, the housing 151 is fixedly installed at a bottom of the first installation chamber 14, the circuit board 152 is arranged in the housing 151, the ultrasonic generator 153 is arranged in the middle of the circuit board 152, the plurality of support rods 154 are arranged around the circumferential side of the circuit board 152, a top of each of the support rods 154 is connected to the vibration plate 155, and the vibration plate 155 is connected to the ultrasonic generator 153; when the ultrasonic generator 153 operates, vibrations are generated through the vibration plate 155, the kinetic energy transfer component 157 is connected to the vibration plate 155, and when the vibration plate 155 vibrates at high frequency, the vibrations are transmitted through the kinetic energy transfer component 157, which vibrates liquid in the extraction chamber 13 and achieves extraction; and since the present disclosure is used for beverages, a food-grade material is used to ensure safety.

Further, in this example, a bottom of the circuit board 152 is spaced apart from the bottom of the housing 151 through the support columns 156; specifically, since the ultrasonic generator 153 generates high-frequency vibrations during operation, a plurality of the support columns 156 are arranged at the bottom of the circuit board 152 to prevent resonance in the kettle body 10, and the support columns 156 support the circuit board 152 such that that the ultrasonic generator 153 is suspended inside the housing 151, thereby avoiding resonance.

Further, in this example, the kettle body 10 is made of stainless steel, silicone, or glass; and

specifically, since the present disclosure employs the ultrasonic extraction method, the kettle body 10 is preferably made of stainless steel or silicone to ensure an extraction effect, glass can be used based on user needs, and the kettle body 10 made of glass may affect attenuate ultrasonic frequency vibrations. Therefore, stainless steel or silicone is preferred in the present disclosure to ensure the extraction effect.

Further, in this example, the stirrer 12 includes: a control board 121, a motor 122, and a stirring paddle 123; the control board 121 and the motor 122 are located inside the second installation chamber 16, and the stirring paddle 123 is located outside the second installation chamber 16 and is connected to an output end of the motor 122; and

specifically, both the control board 121 and the motor 122 are located inside the second installation chamber 16, the second installation chamber 16 is arranged in a sealed manner to prevent liquid from entering the second installation chamber 16, the stirring paddle 123 is located outside the second installation chamber 16, the stirring paddle 123 is connected to the output end of the motor, and the motor 122 drives the stirring paddle 123 to stir the liquid.

Further, power of the ultrasonic assembly 15 is 50-200 W; and

specifically, the power of the ultrasonic assembly 15 can be adjusted within a range of 20-200 W to adapt to different roast levels of coffee powder, light roast requires a higher frequency to release floral and fruity aromas, and dark roast requires a lower frequency to reduce bitterness, where the power of 50-100 W and the frequency of 20-40 kHz are more suitable for making tea. Preset parameters can be intelligently configured through an intelligent control system to meet different use needs.

To sum up, the cavitation effect of ultrasonic waves significantly shortens extraction time, enhances the extraction effect, accelerates the dissolution of water-soluble substances, and ensures thorough dissolution of water-soluble substances, flavor concentration, more full aroma release, and reduction of bitterness; and low-temperature stirring enables to reduce the loss of volatile aromas in coffee and enhance the taste smoothness, which is suitable for a wide range of applications, and facilitates mass production.

The present disclosure is not limited merely to what is described in the specification and the implementation modes, such that additional advantages and modifications can be readily achieved by those skilled in the art. Without departing from the spirit and scope of the general concept as defined by the claims and the equivalents, the present disclosure is not limited to the specific details, representative apparatus, and illustrative examples as shown and described herein.

1. A top-mounted ultrasonic extraction device, comprising: a kettle body, wherein a kettle lid is detachably arranged on a top of the kettle body, a first installation chamber is arranged inside the kettle lid, an ultrasonic assembly is fixedly installed inside the first installation chamber, an extraction chamber and a second installation chamber are sequentially vertically arranged inside the kettle body, the second installation chamber is arranged in a sealed manner, a stirrer is arranged inside the second installation chamber, the ultrasonic assembly is connected to a kinetic energy transfer component, and the kinetic energy transfer component extends into the extraction chamber; and the ultrasonic assembly generates vibrations at a frequency of 20-50 kHz, and the vibrations are transmitted to the extraction chamber through the kinetic energy transfer component.

2. The top-mounted ultrasonic extraction device according to claim 1, wherein the ultrasonic assembly comprises: a housing, wherein a circuit board is arranged at a bottom of the housing, an ultrasonic generator is arranged in a middle of the circuit board, a plurality of support rods are arranged around a circumferential side of the circuit board, one end of each of the support rods, away from the circuit board, is connected to a vibration plate, the ultrasonic generator is further connected to the vibration plate, and the kinetic energy transfer component is connected to the vibration plate.

3. The top-mounted ultrasonic extraction device according to claim 2, wherein a bottom of the circuit board is spaced apart from the bottom of the housing through support columns.

4. The top-mounted ultrasonic extraction device according to claim 1, wherein the kettle body is made of stainless steel, silicone, or glass.

5. The top-mounted ultrasonic extraction device according to claim 1, wherein the stirrer comprises: a control board, a motor, and a stirring paddle; the control board and the motor are located inside the second installation chamber, and the stirring paddle is located outside the second installation chamber and is connected to an output end of the motor.

6. The top-mounted ultrasonic extraction device according to claim 1, wherein power of the ultrasonic assembly is 50-200 W.
